(19) United States
(12) Patent Application Publication
(10) Pub. No.: US 2004/0053078 A1
(43) Pub. Date: Mar. 18, 2004

(54) Magnetic recording medium and magnetic recording/reproducing apparatus

(75) Inventors: Akira Kikitsu, Yokohama-shi (JP); Junichi Akiyama, Kawasaki-shi (JP); Tadashi Kai, Kawasaki-shi (JP); Toshihiko Nagase, Kawasaki-shi (JP); Tomoyuki Maeda, Yokohama-shi (JP); Hisanori Aikawa, Yokohama-shi (JP); Soichi Oikawa, Chiba-shi (JP); Yoichiro Tanaka, Kawasaki-shi (JP)

Correspondence Address: PILLSBURY WINTHROP, LLP, P.O. BOX 10500, MCLEAN, VA, 22102, US

(73) Assignee: Kabushiki Kaisha Toshiba, Tokyo (JP)

(21) Appl. No.: 10/607,570

(22) Filed: Jun. 27, 2003

(30) Foreign Application Priority Data
Jun. 28, 2002 (JP) 2002-191394

(51) Int. Cl. G11B 5/66

(52) U.S. Cl. 428/694 TM; 428/694 R

(57) ABSTRACT

This invention uses a perpendicular magnetic recording medium in which first and second magnetic recording layers are coupled by antimagnetic exchange coupling, or a longitudinal magnetic recording medium in which three or more predetermined interlayers are formed between first and second magnetic recording layers, and these layers are coupled by antimagnetic exchange coupling.

### CROSS-REFERENCE TO RELATED APPLICATION

This application is based upon and claims the benefit of priority from the prior Japanese Patent Application No. 2002-191394, filed Jun. 28, 2002, the entire contents of which are incorporated herein by reference.

### BACKGROUND OF THE INVENTION

1. Field of the Invention

The present invention relates to a magnetic recording/reproducing apparatus used as a hard disk drive, and a magnetic recording medium for use in the apparatus.

2. Description of Related Art

With a recent increase in computer's processing speed, a magnetic storage device (HDD) for storing and reproducing information and data is increasingly required to have higher speed and density. However, increasing the density presumably has its physical limits, so it is doubtful whether this requirement can be kept satisfied.

A magnetic recording medium has a magnetic recording layer which is an aggregate of fine magnetic grains. To perform high-density recording, it is necessary to decrease the size of magnetic domains to be recorded in this magnetic recording layer. To distinguish each small recording magnetic domains, the boundaries of them must be smooth. To this end, the size of magnetic grains forming the magnetic domains must be decreased. When the magnetization reversal occurs successively to adjacent magnetic grains, the boundary between magnetic domains is disturbed. Therefore, individual magnetic grains must be magnetically separated by a nonmagnetic material, so that no exchange coupling interaction occurs between them. Furthermore, from the viewpoint of magnetic interaction between a head and the medium, the film thickness of the magnetic recording layer must be reduced to perform high-density recording.

To meet the above requirements, it is necessary to decrease the volume of the magnetization reversal unit (magnetic grain) of the magnetic recording layer. When the size of this magnetization reversal unit is decreased, the magnetic anisotropy energy of the unit, i.e., magnetic anisotropy energy density Ku X magnetization reversal unit volume V becomes smaller than the thermal fluctuation energy at room temperature. Then magnetic domains cannot be held any longer. This is a thermal fluctuation phenomenon. A recording density's physical limit mainly caused by this phenomenon is called a thermal fluctuation limit.

Magnetization reversal caused by thermal decay can be prevented by increasing Ku. However, no data can be recorded by a magnetic field from a present recording head since the coercive force is substantially proportional to Ku.

As a means for avoiding this thermal decay problem, a perpendicular magnetic recording system is proposed in addition to increasing Ku. In this perpendicular magnetic recording system, the axis of easy magnetization which is in the longitudinal direction of a magnetic recording medium in the conventional longitudinal magnetic recording system is made perpendicular to the magnetic recording medium. Accordingly, demagnetizing fields cancel each other out near a magnetization transition region (the boundary between recording magnetic domains). As a consequence, as the recording density increases, the magnetic recording medium becomes magnetostatically stable, and its thermal decay resistance increases. Therefore, this perpendicular magnetic recording system is suited to increasing the recording density. However, opposite to the longitudinal magnetic recording system, the larger the distance from the magnetization transition region, the larger the demagnetizing fields. Consequently, reversed magnetic domains are generated in a portion where the recording density is low, and this increases the medium (DC) noise.

As a solution of the thermal decay problem for the longitudinal magnetic recording medium, an antiferromagnetic coupling recording medium is proposed. In this medium, a recording layer made of a magnetic material is divided into two layers. These two layers are stacked with a nonmagnetic metal such as Ru having a thickness of about 1 nm interposed between them, so that the magnetization directions in these layers are opposite. This decreases Mrt (Mr is remanent magnetization, and t is the film thickness), reduces the demagnetizing fields in the magnetization transition region, and increases the recording resolution.

In the antiferromagnetic coupled longitudinal magnetic recording medium, antiferromagnetic coupling energy J is preferably large to some extent. However, only J of about 0.1 erg/cm² can be obtained when an interlayer is simply inserted. As a means for obtaining a large J value, therefore, a method of inserting Co layers about 1 nm thick before and after the interlayer is proposed. Unfortunately, when Co layer is inserted, Co atoms diffuse into the recording layer to degrade the magnetic separation between magnetic grain boundaries, thereby increasing the medium noise. To cancel this drawback, an alloy layer consisting primarily of Co, e.g., a CoCr layer can be inserted. However, J undesirably lowers in this case.

In the perpendicular magnetic recording medium, an antiferromagnetically coupled state is difficult to realize even if magnetic recording layers are stacked by similarly interposing a nonmagnetic layer such as Ru. This is so because the anti-parallel state (the spin directions in two layers are opposite) is magnetostatically unstable for the perpendicular magnetic recording medium, while it is stable for the longitudinal magnetic recording medium. An antiferromagnetically coupled state may be obtained even in the perpendicular magnetic recording medium if antiferromagnetic coupling energy exceeding the magnetostatic energy is obtained. However, even if this antiferromagnetically coupled state is obtained, the demagnetizing fields presumably hardly reduce in the magnetization transition region owing to the magnetostatic mechanism. So, the same effect as the longitudinal recording medium is difficult to obtain. For these reasons, no perpendicular magnetic recording medium with the antiferromagnetic coupled state has been realized yet.

### BRIEF SUMMARY OF THE INVENTION

The present invention may provide in consideration of the situations of the above prior art, and the first embodiment of the present invention can reduce the medium noise in a low-density region and increase the recording resolution for a perpendicular magnetic recording medium, and can further increase a areal recording density exceeding the thermal decay limit of a longitudinal magnetic recording medium using longitudinal antiferromagnetic coupling.

The second embodiment of the present invention can provide a magnetic recording/reproducing apparatus capable of recording at a high areal density exceeding the thermal decay limit of the conventional longitudinal magnetic recording system using longitudinal antiferromagnetic coupling, by reducing the medium noise in a low-density region and increasing the recording resolution for a perpendicular magnetic recording medium.

According to an embodiment of the present invention, a magnetic recording medium comprising a nonmagnetic substrate, a first magnetic recording layer formed on the nonmagnetic substrate, and a second magnetic recording layer formed on the first magnetic recording layer, characterized in that the first and second magnetic recording layers interact each other to make their magnetization directions antiparallel, and the axis of easy magnetization in each of the first and second magnetic recording layers is perpendicular to the plane of the layer.

### BRIEF DESCRIPTION OF THE SEVERAL VIEWS OF THE DRAWING

The accompanying drawings, which are incorporated in and constitute a part of the specification, illustrate presently embodiments of the invention and, together with the generation description given above and the detailed description of the embodiments given below, serve to explain the principles of the invention.

FIG. 1 is a view showing the arrangement of an example of a magnetic recording medium according to the present invention;

FIG. 2 is a graph showing magnetization curves of the magnetic recording medium according to the present invention;

FIGS. 3A to 3C are views schematically showing the magnetization directions in magnetic recording layers;

FIG. 4 is a schematic view showing a magnetization transition region in first and second magnetic recording layers;

FIG. 5 is a schematic view for explaining the magnetization directions in a conventional perpendicular magnetic recording medium;

FIG. 6 is a schematic view for explaining the magnetization directions in a perpendicular magnetic recording medium according to the present invention;

FIG. 7 is a view showing an example of a magnetic recording medium having interlayers;

FIG. 8 is a view showing another example of the magnetic recording layer having interlayers;

FIG. 9 is a view showing the arrangement of another example of the magnetic recording medium according to the present invention;

FIG. 10 is a partially exploded perspective view showing an example of a magnetic recording/reproducing apparatus according to the present invention;

FIG. 11 is a graph showing other examples of the magnetization curves of the magnetic recording medium of the present invention;

FIG. 12 is a view schematically showing a magnetic recording/reproducing apparatus including an auxiliary head;

FIG. 13 is a view for explaining an example of another auxiliary head used in the present invention;

FIG. 14 is a view for explaining an example of another auxiliary head used in the present invention;

FIG. 15 is a view showing the arrangement of an example of a ring head applicable to the magnetic recording/reproducing apparatus of the present invention;

FIG. 16 is a view showing the arrangement of a single pole head applicable to the magnetic recording/reproducing apparatus of the present invention;

FIG. 17 is a graph showing still other examples of the magnetization curves of the magnetic recording medium according to the present invention;

FIG. 18 is a graph showing the dependence of J upon Ir thickness;

FIG. 19 is a graph showing a medium noise reduction −ΔNdc (dB) as a function of a surface density J;

FIG. 20 is a graph showing a change in an antiferromagnetic coupling energy surface density J as a function of a thickness t (nm) of a Co interlayer; and

FIG. 21 is a graph showing the relationship between a thickness t of a Pt interlayer and J.

### DETAILED DESCRIPTION OF THE INVENTION

A magnetic recording medium according to a first aspect of the present invention comprises a nonmagnetic substrate, a first magnetic recording layer formed on the nonmagnetic substrate, and a second magnetic recording layer formed on the first magnetic recording layer, and the first and second magnetic recording layers interact each other to make their magnetization directions antiparallel, and the axis of easy magnetization in each of the first and second magnetic recording layers is perpendicular to the plane of the layer.

The presence or absence of antiferromagnetic coupling which causes the first and second magnetic recording layers to interact each other to make their magnetization directions antiparallel can be confirmed by the magnetization curves.

The present invention is described in more detail below with reference to the accompanying drawing.

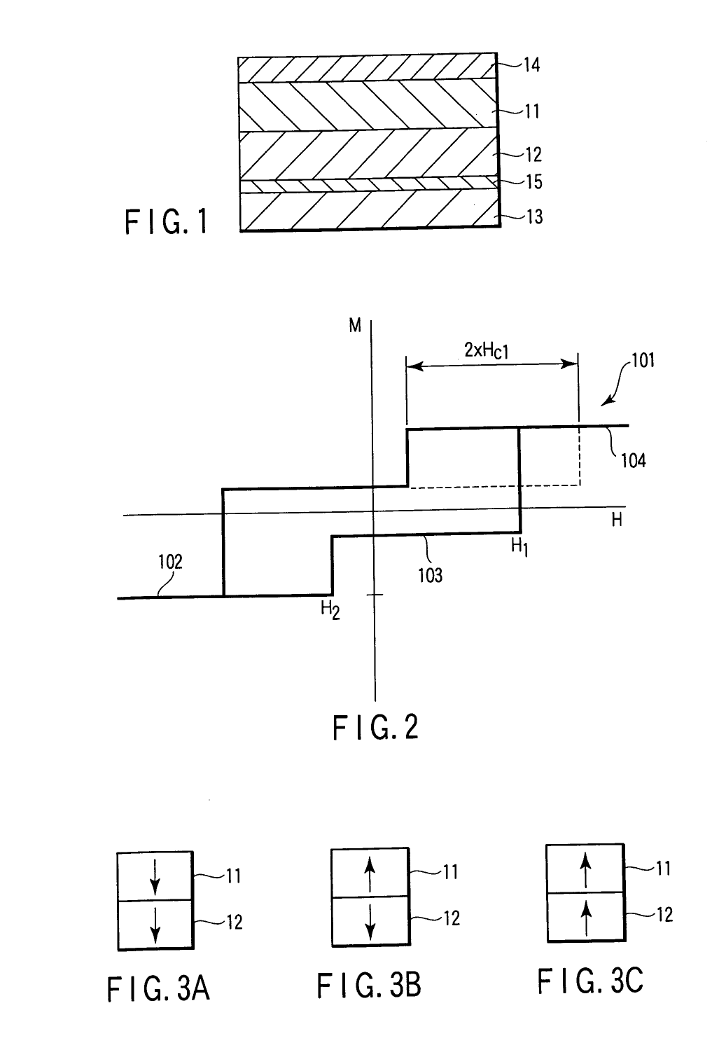

FIG. 1 is a view schematically showing the arrangement of an example of a magnetic recording medium according to the present invention.

As shown in FIG. 1, this medium is a perpendicular magnetic recording medium in which an underlayer 15 made of, e.g., Pd or Pt, a first magnetic recording layer 12 made of, e.g., a multilayered structure of Co and Pt, a second magnetic recording layer 11 made of, e.g., a segregated structure of CoPtTa alloy grins and SiO₂, and a protective layer made of, e.g., C, are stacked in order on a substrate 13 made of, e.g., glass.

FIG. 2 shows a magnetization curves of this perpendicular magnetic recording medium shown in FIG. 1. This is so-called a hysteresis loop. FIGS. 3A, 3B, and 3C schematically illustrate, by using arrows, the magnetization directions in the first and second magnetic recording layers 12 and 11 when a magnetic field larger than −H₁ is applied in the negative direction as indicated by a curve 102, when this magnetic field reduces to become larger than H₂ and smaller than H₁ as indicated by a curve 103, and when a large magnetic field is applied in the positive direction as indicated by a curve 104, respectively. As shown in FIG. 3A, when a strong magnetic field is applied in the negative direction, magnetization is downward in each layer. When this magnetic field reduces to exceed H₂, the magnetization direction in the second magnetic recording layer is reversed, resulting in the state shown in FIG. 3B. This state is stable in energy owing to antiferromagnetic exchange coupling. When a larger magnetic field H₁ is applied, as shown in FIG. 3C, magnetization is upward in each layer.

A dotted line 201 in FIG. 2 indicates a minor loop. Referring to FIG. 2, the second magnetic recording layer reverses earlier, so only this reversal of the second magnetic recording layer contributes to the minor loop. The width of the minor loop is represented by a coercive force H_{cl} of the second magnetic recording layer. When there is no antiferromagnetic exchange coupling, the minor loop is symmetrical with respect to H=0. If antiferromagnetic coupling exists, as shown in FIG. 2, the minor loop shifts to the right. The presence of this shift indicates the existence of antiferromagnetic coupling. That is, the effect of an antiferromagnetically coupled medium is achieved when a reversal magnetic field H₁ of the first magnetic recording layer and a reversal magnetic field H₂ of the second magnetic recording layer have opposite signs. Note that no two-stage loop is formed when ferromagnetic exchange coupling exists.

The present inventors have found that when the first and second magnetic recording layers have antiferromagnetic coupling as described above, high-density magnetic recording exceeding the conventional thermal decay limit can be obtained.

Also, the present inventors have found by detailed analysis of a perpendicular recording system that the antiferromagnetic coupling between the first and second magnetic recording layers decreases the magnetization transition width even in a perpendicular magnetic recording medium.

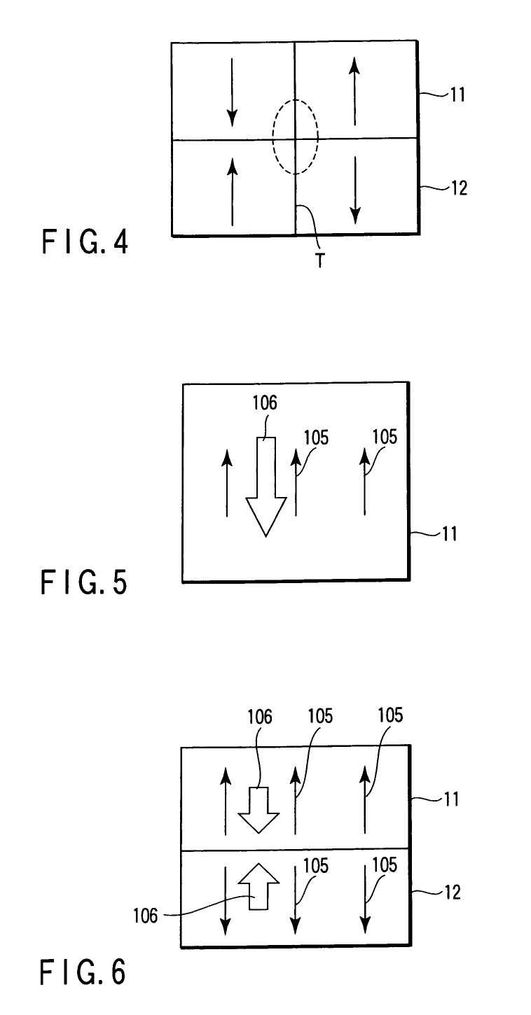

FIG. 4 is a schematic view showing a magnetization transition region in the first and second magnetic recording layers. Magnetization transition occurs around a position indicated by T. The antiferromagnetic coupling between the first and second magnetic recording layers reduces a demagnetizing field in a small region indicated by the dotted line in FIG. 4, while the other portion of the magnetization transition region is under the influence of a demagnetizing field similar to that in conventional perpendicular magnetic recording. However, the present inventors have found by micromagnetic analysis that this local reduction in the demagnetizing field greatly decreases the magnetization transition width. Accordingly, the recording resolution of a perpendicular medium can be improved by antiferromagnetic coupling.

Furthermore, the present inventors have found that the use of the antiferromagnetically coupled magnetic recording layers described above suppresses the generation of reversed magnetic domains.

FIG. 5 is a schematic view for explaining the magnetization directions in the conventional perpendicular magnetic recording medium.

FIG. 6 is a schematic view for explaining the magnetization directions in the perpendicular magnetic recording medium according to the present invention.

As shown in FIG. 5, in the conventional perpendicular magnetic recording medium, when magnetic domains with the same magnetization direction continue as indicated by arrows 105, a large demagnetizing field indicated by an arrow 106 is generated. This demagnetizing field reverses the magnetization of some magnetic domains, leading to an increase in medium noise.

In the magnetic recording medium according to the present invention as shown in FIG. 6, however, demagnetizing fields indicated by arrows 106 are generated in the two layers and cancel each other out at the interface. This reduces demagnetizing fields in the whole film and suppresses the generation of reversed magnetic domains.

Furthermore, the present inventors have found by dynamics analysis using the micromagnetics technology that a perpendicular magnetic recording medium using antiferromagnetic coupling can record data with no particularly large head magnetic field applied, although the coercive force increases. When the first and second magnetic recording layers are antiferromagnetically coupled, the reversal magnetic field indicated by H₁ in FIG. 2 is larger than the coercive force of the first and second magnetic recording layers. Therefore, to apply antiferromagnetically coupled magnetic layers to a magnetic recording medium, a large write magnetic field is necessary. It is conventionally presumed that since the writing magnetic field is raised to its physical limit value in order to overcome the thermal decay problem, the use of antiferromagnetically coupled magnetic layers cannot be effective to increase the recording density. That is, it is conventionally assumed that the thermal decay limit of a perpendicular magnetic recording medium using antiferromagnetic coupling is difficult to raise, because a predetermined recording magnetic field increases.

The present inventors, however, have found for the first time by detailed analysis that the write magnetic field supplied from the head is strong in the second magnetic recording layer and weak in the first magnetic recording layer. Accordingly, the reverse magnetic field indicated by H₁ in FIG. 2 is smaller than in hysteresis loop under a uniform magnetic field. Also, usually magnetization of the second magnetic recording layer reverses first and then magnetization of the first magnetic recording layer reverses in the opposite direction after the head magnetic field passes. However, magnetization of the first magnetic recording layer can start reversing while the head magnetic field still exists because of the difference in the magnetic field between the layers. This allows magnetization reversal in the second magnetic recording layer with a smaller magnetic field, thereby enabling data recording.

In an embodiment of a magnetic recording medium of the present invention, first and second magnetic recording layers are stacked on a nonmagnetic substrate so as to cause antiferromagnetic exchange coupling interaction at room temperature. In addition, the second magnetic recording layer is made up of magnetic grains and a nonmagnetic material present between these magnetic grains, and the first and second magnetic recording layers have perpendicular magnetic anisotropy.

Generally, a hard material can be used as the nonmagnetic substrate. Examples are a metal, glass, and ceramics.

In the magnetic recording medium according to the present invention, a protective layer and/or underlayer made of, e.g., C or SiO₂ can be used when necessary.

The material of the magnetic grains forming the second magnetic recording layer preferably has large saturation magnetization Is and large magnetic anisotropy.

An example of this magnetic material is at least one material selected from the group consisting of Co, Pt, Sm, Fe, Ni, Cr, Mn, Bi, Al, and alloys of these metals. Of these materials, Co-based alloys having large crystal magnetic anisotropy, particularly, CoPt—, SmCo—, and CoCr-based alloys. Ordered phase alloys such as FePt and CoPt are more preferred. Practical examples are Co—Cr, Co—Pt, Co—Cr—Ta, Co—Cr—Pt, Co—Cr—Ta—Pt, Fe₅₀Pt₅₀, Fe₅₀Pd₅₀, and Co₃Pt₁. In addition to these alloys, the magnetic material can be widely selected from rare earth-transition metal alloys such as Tb—Fe, Tb—Fe—Co, Tb—Co, Gd—Tb—Fe—Co, Gd—Dy—Fe—Co, Nd—Fe—Co, and Nd—Tb—Fe—Co, multilayered films of magnetic layers and noble metal layers such as Co/Pt and Co/Pd, halfmetals such as PtMnSb, and oxides such as Co ferrite and Ba ferrite.

For the purpose of controlling the magnetic characteristics, the above magnetic material can also be alloyed with at least one element selected from Fe and Ni. It is also possible to add elements for improving the magnetic characteristics to these metals or alloys. Examples are Cr, Nb, V, Ta, Ti, W, Hf, Cr, V, In, Si, and B. Compounds of these elements and at least one element selected from oxygen, nitrogen, carbon, and hydrogen can also be used.

The magnetic anisotropy of the magnetic recording layer can contain a longitudinal component, as long as a perpendicular component is the main component.

The thickness of the magnetic recording layer used in the present invention is not particularly restricted. For high-density recording, however, the thickness is preferably 100 nm or less, more preferably, 50 nm or less, and most preferably, 20 nm or less. If the thickness is 0.1 nm or less, thin films become difficult to form.

As a method of separating the magnetic grains in the magnetic recording layer, a nonmagnetic element such as Cr, Ta, B, an oxide represented by SiO₂, or a nitride can be added to the magnetic grains and precipitated between them. Alternatively, the magnetic grains can be separated by artificial processing using a technique such as lithography used for semiconductors. The magnetic grains can also be separated by self-organizing process using a diblock copolymer, e.g., PS-PMMA. Furthermore, the magnetic grains can be separated by process using a particle (ion) beam irradiation.

The material of the first magnetic recording layer is not particularly limited as long as the material is a magnetic material. The magnetic anisotropy of this first magnetic recording layer can contain a longitudinal magnetic anisotropic component, provided that a perpendicular magnetic anisotropic component is the main component. If the thickness of the first magnetic recording layer is 1,000 nm or more, the formation tends to take a long time and characteristic deterioration and peeling tend to be caused by film stress. If the thickness is 0.1 nm or less, it is difficult to form thin films. Requirements of the magnetic materials in the first magnetic recording layer are the same as the second magnetic recording layer.

Exchange coupling between the first and second magnetic recording layers can be realized by forming these layers in succession without breaking the vacuum in a general magnetic recording layer formation process using sputtering or the like. The energy can preferably be lowest when the magnetization directions in the first and second magnetic recording layers are antiparallel. This requirement can be achieved by controlling the state of the interface between the first and second magnetic recording layers. For example, to form a region in which magnetic characteristic is changed at the interface, to modify a surface region at the interface or to form physical/chemical adsorption layers at the interface are preferable. Since the exchange interaction is theoretically effective even when the first and second magnetic recording layers are separated by about a few nm, nonmagnetic layers can be formed between the first and second magnetic recording layers as long as exchange coupling acts. Also, the exchange coupling force can be controlled by inserting another magnetic layer between the first and second magnetic recording layers. Accordingly, a plurality of magnetic layers can be formed between the first and second magnetic recording layers, provided that the effect of the present invention is not spoiled.

The underlayer can be either a magnetic material or nonmagnetic material. If the thickness is larger than 500 nm, the manufacturing cost tends to increase.

In the case of a perpendicular double-layered medium using a soft magnetic under layer, the underlayer thickness is preferably small, i.e., preferably 50 nm or less, and more preferably, 20 nm or less. The thickness can also be 0 nm if the grain size and alignment of the magnetic recording layer can be controlled.

To perform efficient recording and reproduction for the magnetic layer, the underlayer made of a magnetic material is magnetically coupled with magnetic domains in the magnetic recording layer and with a recording/reproducing head via exchange interaction and magnetostatic interaction. In particular, a so-called double-layered perpendicular recording medium can record data at high density, in which a soft magnetic layer between the first magnetic recording layer and substrate is formed and recording is performed by a single pole head.

The underlayer made of a nonmagnetic material is formed to control the crystal structure of the magnetic grains and nonmagnetic material in the magnetic recording layer, or to prevent mixing of impurities from the substrate. For example, the crystal state of the magnetic grains can be controlled by using an underlayer having a lattice spacing close to that of the desired crystal alignment of the magnetic grains. Also, the crystallinity or amorphous properties of the magnetic grains or nonmagnetic material can be controlled by using an amorphous underlayer having a certain surface energy. An underlayer can also be formed below another underlayer. In this case, better effects can be expected by assigning functions to these underlayers. For example, a seed layer having a small grain size is formed on the substrate in order to decrease the size of the magnetic crystal grains in the magnetic recording layer, and another underlayer for controlling the crystallinity of the magnetic recording layer is formed on this seed layer. To prevent mixing of impurities from the substrate, a thin film having a small lattice spacing can be used as the underlayer.

The functions of the magnetic and nonmagnetic underlayers are interchangeable. That is, it is possible to form, e.g., a magnetic underlayer for controlling the crystallinity of the magnetic grains in the magnetic recording layer. In this case, the effect on the recording/reproducing characteristics and the effect on the crystallinity are combined. The underlayer can be a substrate surface modification layer formed by, e.g., ion plating, doping in an ambient gas, or neutron beam irradiation. The fabrication cost can be reduced in this case since no thin film deposition process need be performed.

Examples of the material of the underlayer are B, C, Al, Si, P, Ti, V, Cr, Mn, Fe, Co, Ni, Cu, Zn, Zr, Nb, Mo, Ru, Rh, Pd, Ag, Hf, Ta, W, Ir, Pt, Au, combinations of these materials, and oxides and nitrides of these materials.

Another embodiment of the magnetic recording medium of the present invention is a perpendicular magnetic recording medium comprising a nonmagnetic substrate, a first magnetic recording layer formed on the nonmagnetic substrate, and a second magnetic recording layer formed on the first magnetic recording layer, wherein the first and second magnetic recording layers interact each other to make their magnetization directions antiparallel, the axis of easy magnetization in each of the first and second magnetic recording layers is perpendicular to the plane of the layer, and the antiferromagnetic exchange coupling energy density is 0.01 erg/cm² or more.

No detailed analysis has been made to date on the value of a magnetic anisotropy energy density Ku as the thermal decay resistance of an antiferromagnetically coupled multilayered magnetic recording medium. However, the present inventors made extensive studies on this magnetic anisotropy energy density Ku and reached the following findings. For example, when layers “1” and “2” are coupled by an exchange coupling energy surface density σ, the total energy surface density of magnetic anisotropy energy as the thermal decay resistance is

if σ/(2t₂Ku₂)<1, t₁Ku₁+σ−σ2/(4t₂Ku₂)

if σ/(2t₂Ku₂)>1, t₁Ku₁+t₂Ku₂

where t₁ and t₂ are the film thicknesses of layers “1” and “2”, respectively, and Ku₁ and Ku₂ are the Ku values of layers “1” and “2”, respectively.

Assuming that layer “1” is the second magnetic recording layer and layer “2” is the first magnetic recording layer in the above expressions, the first magnetic recording layer increases the entire magnetic anisotropy energy surface density, so the thermal decay resistance increases. However, the total thickness t₁+t₂ cannot be unlimitedly increased since the magnetic field is reduced far from the recording head. The thermal decay resistance decreases when the total thickness is equivalent to the thickness of the second magnetic recording layer. In addition, t₁+t₂ is preferably as small as possible when the manufacturing cost of the magnetic recording medium is taken into account. Accordingly, to increase the thermal decay resistance under the conditions, the exchange coupling energy surface density a is favorably large as is apparent from the above expressions. If this value is too large, however, the reversal magnetic field of the medium increases. So, the upper limit is desirably set to meet the system requirements. The lower limit is preferably set to such an extent that the thermal decay resistance does not significantly lower. Detailed experiments using the magnetic recording medium of the present invention reveal that the antiferromagnetic exchange coupling energy surface density is preferably 0.01 erg/cm² or more, and more preferably, 0.1 to 1 erg/cm².

Still another embodiment of the magnetic recording medium of the present invention is a perpendicular magnetic recording medium comprising a nonmagnetic substrate, a first magnetic recording layer formed on the nonmagnetic substrate, and a second magnetic recording layer formed on the first magnetic recording layer, wherein the first and second magnetic recording layers interact each other to make their magnetization directions antiparallel, the axis of easy magnetization in each of the first and second magnetic recording layers is perpendicular to the plane of the layer, a first interlayer M1 is formed between the first and second magnetic recording layers, and the thickness of this first interlayer M1 is 2 nm or less.

When the interlayer M1 is inserted between the first and second magnetic recording layers, a large antiferromagnetic exchange coupling energy surface density can be obtained.

Examples of the material of the interlayer M1 used in the present invention are nonmagnetic metal materials such as Ru, Re, Rh, Ir, Tc, Au, Ag, Cu, Si, Fe, Ni, Pt, Pd, Cr, Mn, and Al.

Other examples of the material of this interlayer M1 are a semiconductor, and a semiconductor material formed by doping a semiconductor with a magnetic material. When this semiconductor material is used, a large exchange coupling energy can be obtained. When the interlayer M1 is a semiconductor, the exchange coupling interaction between the first and second magnetic recording layers presumably is brought by the spin polarized electrons (carriers). Since the generation of electrons (carriers) is important, it is possible to use, e.g., Si, Ge, Sn, Te, AlP, GaN, GaP, GaAs, InSb, ZnO, ZnS, or ZnTe as a semiconductor. Generally, the magnetic material to be doped is, e.g., Co, Fe, Ni, Mn, or Cr.

Still another embodiment of the magnetic recording medium of the present invention is a perpendicular magnetic recording medium comprising a nonmagnetic substrate, a first magnetic recording layer formed on the nonmagnetic substrate, and a second magnetic recording layer formed on the first magnetic recording layer, wherein the first and second magnetic recording layers interact each other to make their magnetization directions antiparallel, the axis of easy magnetization in each of the first and second magnetic recording layers is perpendicular to the plane of the layer, a first interlayer M1 is formed between the first and second magnetic recording layers, the thickness of this first interlayer M1 is 2 nm or less, an interlayer M2 is inserted between the interlayer M1 and second magnetic recording layer, and/or an interlayer M3 is inserted between the interlayer M1 and first magnetic recording layer, the interlayers M2 and M3 contain an alloy which consists primarily of Co, and the thickness of the interlayers M2 and M3 is 2 nm or less.

As the material of the interlayers M2 and M3, a magnetic material consisting primarily of Co is used. To adjust the magnetic characteristics, crystallinity, and the like, another element such as Cr, Ti, Ta, B, or SiO₂ can be added. It is also possible to add a magnetic element such as Ni or Fe.

During the course of experiments for searching for interlayer materials, the present inventors have found that the antiferromagnetic coupling energy density increases when the Co interlayers M2 and M3 having a thickness of 2 nm or less are present between the interlayer and second magnetic recording layer and/or between the interlayer and first magnetic recording layer. The effect was found even when the thickness of the interlayers M2 and M3 was 0.2 nm. When these interlayers M2 and M3 were observed with a cross sectional TEM, islands presumably made of Co were slightly present between the interlayer and first or second magnetic recording layer. The average height of these islands was 0.2 nm. When the present inventors searched for the lower limit, almost no islands were found when the thickness was 0.05 nm or less, and there was no antiferromagnetic coupling increasing effect any longer. Hence, the thickness of the interlayers M2 and M3 is preferably 0.05 to 2 nm.

The effect was found even when these interlayers M2 and M3 were not made of Co alone, i.e., even when they were made of an alloy having another element mixed in it or they were granular films or composite films containing a non-solid-solution material. Also, the antiferromagnetic coupling energy increased regardless of whether the interlayers M3 and M2 were formed in one or both of the interface between the second magnetic recording layer and interlayer M1 and the interface between the first magnetic recording layer and interlayer M1.

One embodiment of the present invention can also provide a magnetic recording medium in which a nonmagnetic substrate, a first magnetic recording layer made of a magnetic material, and a second magnetic recording layer made of a magnetic material are stacked in this order, the second magnetic layer is made up of magnetic grains and a nonmagnetic material present between the magnetic grains, an interlayer M1 is formed between the first and second magnetic recording layers, an interlayer M3 is inserted between the interlayer M1 and second magnetic recording layer, and/or an interlayer M2 is inserted between the interlayer and first magnetic recording layer, an interlayer M5 is inserted between the interlayer M3 and second magnetic recording layer, and/or an interlayer M4 is inserted between the interlayer M2 and first magnetic recording layer, the interlayers M1, M4, and M5 are made of a nonmagnetic material selected from the group consisting of at least Ru, Re, Rh, Ir, Tc, Au, Ag, Cu, Si, Fe, Ni, Pt, Pd, Cr, Mn, Al, a semiconductor, and a magnetic material-doped semiconductor, the interlayers M2 and M3 are made of a magnetic material containing an alloy which consists primarily of Co, each of the interlayers M1, M2, M3, M4, and M5 has a thickness of 2 nm or less, and one or all of the first magnetic recording layer, interlayers M2 and M3, and second magnetic recording layer are coupled by antiferromagnetic exchange coupling.

The first and second magnetic recording layers can have one or both of longitudinal magnetic anisotropy and perpendicular magnetic anisotropy.

During the course of searching for an antiferromagnetically coupled medium structure having the interlayers M1, M2, and M3 described above, the present inventors have found that the antiferromagnetic coupling energy increases when the interlayers M4 and M5 are inserted between the interlayer M2 and first magnetic recording layer and/or between the interlayer M3 and second magnetic recording layer. The requirements to be met by the interlayers M4 and M5 are similar to the interlayer M1. The antiferromagnetic coupling energy increasing effect is independent of the directions of magnetic anisotropy in the first and second magnetic recording layers, i.e., is independent of whether these layers have one or both of longitudinal magnetic anisotropy and perpendicular magnetic anisotropy. To achieve the function of the antiferromagnetically coupled medium described above, it is significant that one or all of the first magnetic recording layer, interlayers, and second magnetic recording layer are coupled by antiferromagnetic exchange coupling. Layers to be antiferromagnetically coupled are determined in accordance with the system performance, e.g., the degree of demagnetizing field reduction, the recording magnetic field characteristics, and the recording density.

Details of the mechanism of increasing the antiferromagnetic coupling energy are unknown. However, when the interlayers M2 and M3 are stacked in contact with the first or second magnetic recording layer, Co as the main component of these interlayers M2 and M3 diffuses to the first or second magnetic recording layer. This makes magnetic separation between the magnetic grains in the first or second magnetic recording layer imperfect. Consequently, effective magnetic anisotropy deteriorates, leading to a decrease in exchange coupling energy. The interlayers M2 and M3 presumably suppress this Co diffusion. Furthermore, the imperfect magnetic separation leads to an increase in medium noise. Therefore, the insertion of the interlayers M4 and M5 also has an effect of preventing an increase in medium noise.

Examples of the combination of the first and second magnetic recording layers and interlayers M1 to M5 are

first recording layer/M1/second recording layer,

first recording layer/M2/M1/second recording layer, first recording layer/M4/M2/M1/second recording layer,

first recording layer/M2/M1/M3/second recording layer, first recording layer/M4/M2/M1/M3/second recording layer,

first recording layer/M2/M1/M3/M5/second recording layer, first recording layer/M4/M2/M1/M3/M5/second recording layer,

first recording layer/M2/M1/M3/M5/second recording layer, first recording layer/M4/M2/M1/M3/M5/second recording layer,

first recording layer/M1/M3/second recording layer, and first recording layer/M1/M3/M5/second recording layer.

The above effect can be obtained by any combination. Increasing the number of layers is undesirable in respect of the manufacturing cost of the medium. However, the antiferromagnetic coupling energy and the direction of coupling can be freely controlled by the interlayers M1, M4, and M5. This makes finer medium design possible. It is also possible to suppress the element diffusion described above and control the crystal structure.

Still another embodiment of the magnetic recording medium of the present invention comprises a nonmagnetic substrate, a first magnetic recording layer formed on the nonmagnetic substrate, and a second magnetic recording layer formed on the first magnetic recording layer, wherein the first and second magnetic recording layers interact each other to make their magnetization directions antiparallel, the magnetic recording medium further comprises an interlayer selected from interlayers M1 to M7 between the first and second magnetic recording layers, the interlayer M1 contains at least one material selected from Ir, Rh, Re, and Ru, the interlayer M6 is inserted between the interlayer M1 and second magnetic recording layer, and/or the interlayer M7 is inserted between the interlayer M1 and first magnetic recording layer, and the interlayers M6 and M7 contain at least one material selected from Pt, Pd, Ru, and Re.

The requirements to be met by the interlayers M6 and M7 are the same as the interlayers M4 and MS except that at least Pt, Pd, Ru, or Re is contained. In addition, at least one of the interlayers M2 and M3 can be omitted.

Examples of the combination of the first and second magnetic recording layers and interlayers M1 to M7 are

first magnetic recording layer/M6/M4/M1/second magnetic recording layer,

first magnetic recording layer/M6/M4/M1/M3/secQnd magnetic recording layer,

first magnetic recording layer/M6/M4/M1/M5/second magnetic recording layer,

first magnetic recording layer/M6/M4/M1/M5/M7/second magnetic recording layer,

first magnetic recording layer/M6/M4/M1/M3/M5/second magnetic recording layer,

first magnetic recording layer/M6/M4/M1/M3/M5/M7/second magnetic recording layer,

first magnetic recording layer/M6/M4/M2/M1/second magnetic recording layer,

first magnetic recording layer/M6/M4/M2/M1/M3/second magnetic recording layer,

first magnetic recording layer/M6/M4/M2/M1/M5/second magnetic recording layer,

first magnetic recording layer/M6/M4/M2/M1/M3/M5/second magnetic recording layer,

first magnetic recording layer/M6/M4/M2/M1/M5/M7/second magnetic recording layer,

first magnetic recording layer/M6/M4/M2/M1/M3/M5/M7/second magnetic recording layer,

first magnetic recording layer/M1/M5/M7/second magnetic recording layer,

first magnetic recording layer/M2/M1/M5/M7/second magnetic recording layer,

first magnetic recording layer/M4/M1/M5/M7/second magnetic recording layer,

first magnetic recording layer/M4/M2/M1/M5/M7/second magnetic recording layer,

first magnetic recording layer/M1/M3/M5/M7/second magnetic recording layer,

first magnetic recording layer/M2/M1/M3/M5/M7/second magnetic recording layer,

first magnetic recording layer/M4/M1/M3/M5/M7/second magnetic recording layer, and

first magnetic recording layer/M4/M2/M1/M3/M5/M7/second magnetic recording layer.

During the course of experiments for searching for interlayer materials, the present inventors have found that when the interlayer M1 contains a material selected from at least Ir, Rh, Re, and Ru, the antiferromagnetic coupling energy density increases if layers containing a material selected from at least Pt, Pd, Ru, and Re are inserted as the interlayers M6 and M7 between the interlayer M1 and first magnetic recording layer and/or between the interlayer M1 and second magnetic recording layer. This effect was obtained regardless of the presence/absence of the interlayers M2 and M3.

Large perpendicular magnetic anisotropy and, in some cases, longitudinal magnetic anisotropy are induced in the interface between a noble metal such as Pt, Pd, Ru, and Re and a thin magnetic film of Co or Fe. Accordingly, when the third interlayer containing a noble metal is brought into contact with the first and second magnetic recording layers and second interlayer, large magnetic anisotropy is induced in the interface between them. This presumably increases the antiferromagnetic exchange coupling.

Still another embodiment of the magnetic recording medium of the present invention comprises a nonmagnetic substrate, a first magnetic recording layer formed on the nonmagnetic substrate, and a second magnetic recording layer formed on the first magnetic recording layer, wherein the first and second magnetic recording layers interact each other to make their magnetization directions antiparallel, the magnetic recording medium further comprises an interlayer selected from interlayers M1 to M7 between the first and second magnetic recording layers, and the interlayers M4 and MS are represented by formula M-G wherein M is selected from at least Si, Al, Zn, Sn, In, Zr, Co, Fe, and B, and G is selected from at least O, N, C, and H.

The present inventors studied a method of preventing the elements forming the interlayers M2 and M3 from being mixed in the first and second magnetic recording layers, and have found that the effect is larger when the interlayers M4 and M5 are made of an oxide or the like than when they are made of a metal. These interlayers M4 and M5 are represented by formula M-G wherein M is selected from at least Si, Al, Zn, Sn, In, Zr, Co, Fe, and B, and G is selected from at least O, N, C, and H.

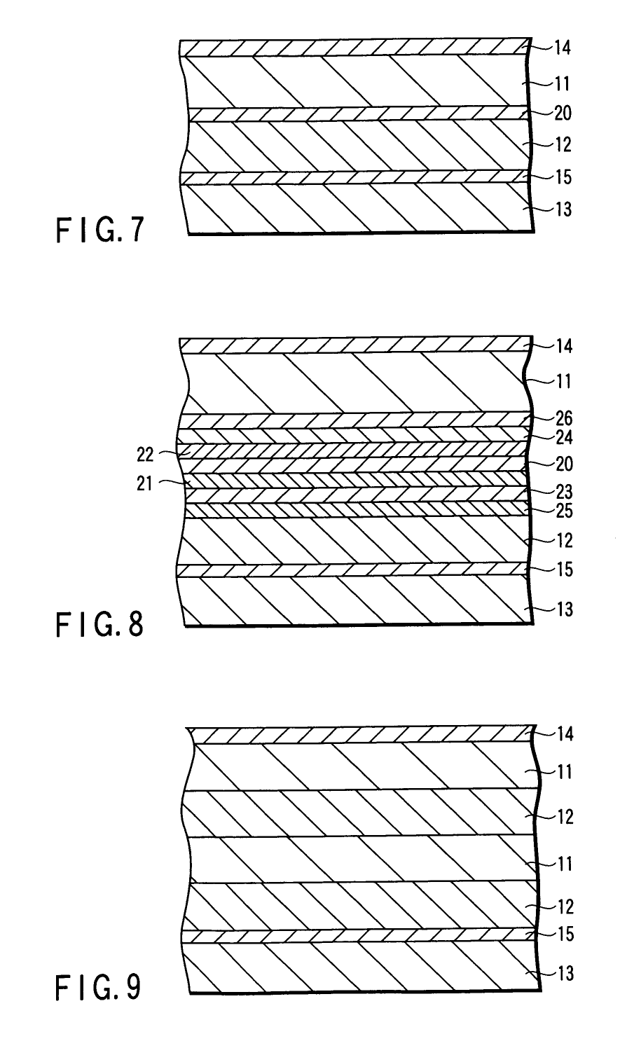

As an example of the magnetic recording medium having the interlayers as described above, FIG. 7 shows a medium in which only the interlayer M1 is formed.

As another example of the magnetic recording medium having the interlayers, FIG. 8 shows a medium in which all the interlayers M1 to M7 are formed.

In FIGS. 7 and 8, reference numerals 20 to 26 denote the interlayers M1 to M7.

Still another embodiment of the magnetic recording medium of the present invention comprises a nonmagnetic substrate, a first magnetic recording layer formed on the nonmagnetic substrate, and a second magnetic recording layer formed on the first magnetic recording layer, wherein the first and second magnetic recording layers interact each other to make their magnetization directions antiparallel, and three or more first and second magnetic recording layers are alternately stacked.

FIG. 9 is a view showing the arrangement of another example of the magnetic recording medium in which three or more first and second magnetic recording layers are stacked.

As shown in FIG. 9, this magnetic recording medium has a structure in which an underlayer, first magnetic recording layer 12, second magnetic recording layer 11, first magnetic recording layer 12, second magnetic recording layer 11, and protective layer are stacked in this order on a nonmagnetic substrate. One or plurality of interlayers (not shown) can also be formed between the first and second magnetic recording layers.

In this structure, the interface of the first or second magnetic recording layers is doubled, so the magnitude of the antiferromagnetic exchange coupling energy or ferromagnetic exchange coupling energy increases for a total recording medium. The advantages obtained by large antiferromagnetic exchange coupling energy or ferromagnetic exchange coupling energy are already described above. However, this structure has the drawback that the total film thickness increases, so the total number of layers and the number of first or second magnetic recording layers forming a unit are so selected as to balance with the system requirements and cost.

A magnetic recording/reproducing apparatus according to the present invention comprises at least one of the magnetic recording media described above, and a means for applying a magnetic field to this magnetic recording medium. It is also possible to use an auxiliary head for applying a magnetic field smaller than the recording magnetic field to the magnetic recording medium after recording.

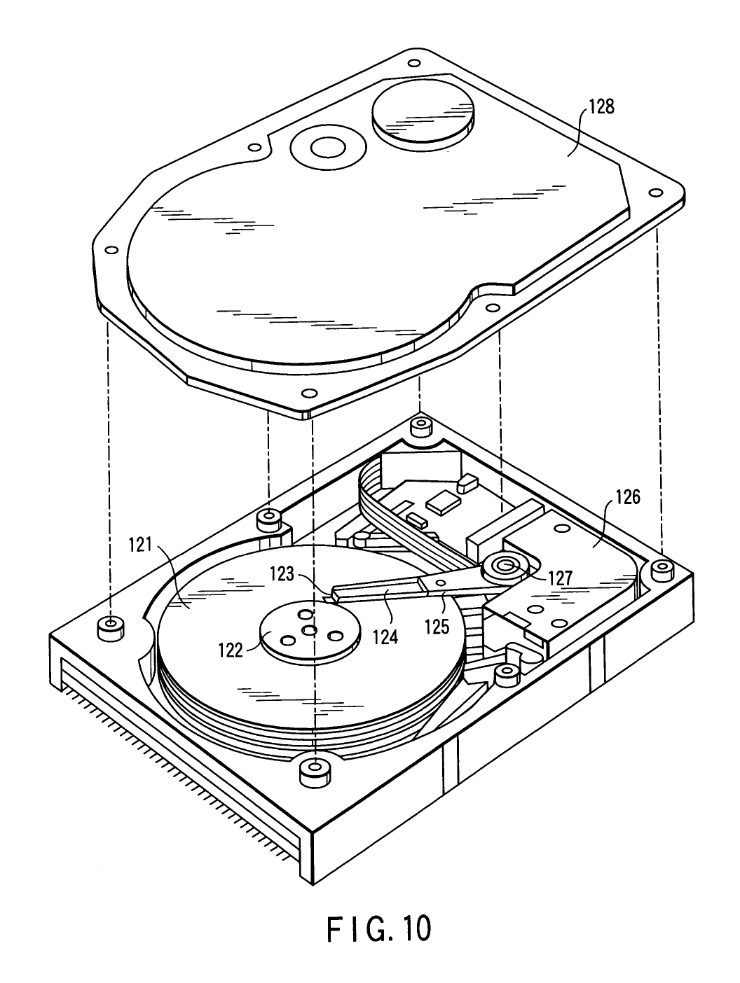

FIG. 10 is a partially exploded perspective view showing an example of the magnetic recording/reproducing apparatus according to the present invention.

A rigid magnetic disk 121 according to the present invention is fitted on a spindle 122 and rotated at a predetermined rotational speed by a spindle motor (not shown). A slider 123 mounting a single pole recording head for accessing the magnetic disk 121 to record information and an MR head for reproducing information is attached to the end portion of a suspension 124 which is a thin leaf spring. This suspension 124 is connected to one end of an arm 125 having, e.g., a bobbin which holds a driving coil (not shown).

A voice coil motor 126 as a kind of a linear motor is attached to the other end of the arm 125. This voice coil motor 126 includes the driving coil (not shown) wound around the bobbin of the arm 125, and a magnetic circuit having a permanent magnetic and counter yoke opposing each other on the two sides of the driving coil.

The arm 125 is held by ball bearings (not shown) formed in two, upper and lower portions of a fixed shaft 127, and pivoted by the voice coil motor 126. That is, the position of the slider 123 on the magnetic disk 121 is controlled by the voice coil motor 126. Reference numeral 128 in FIG. 10 denotes a lid.

As shown in FIG. 2, to achieve the effect of an antiferromagnetically coupled medium, H₁ as a reversal magnetic field of the first or second magnetic recording medium and H₂ as a reversal magnetic field of the other must have opposite signs. Consequently, in a remanent magnetization state having no recording magnetic field, the state in which magnetizations in the first and second magnetic recording layers are antiferromagnetically coupled is naturally formed.

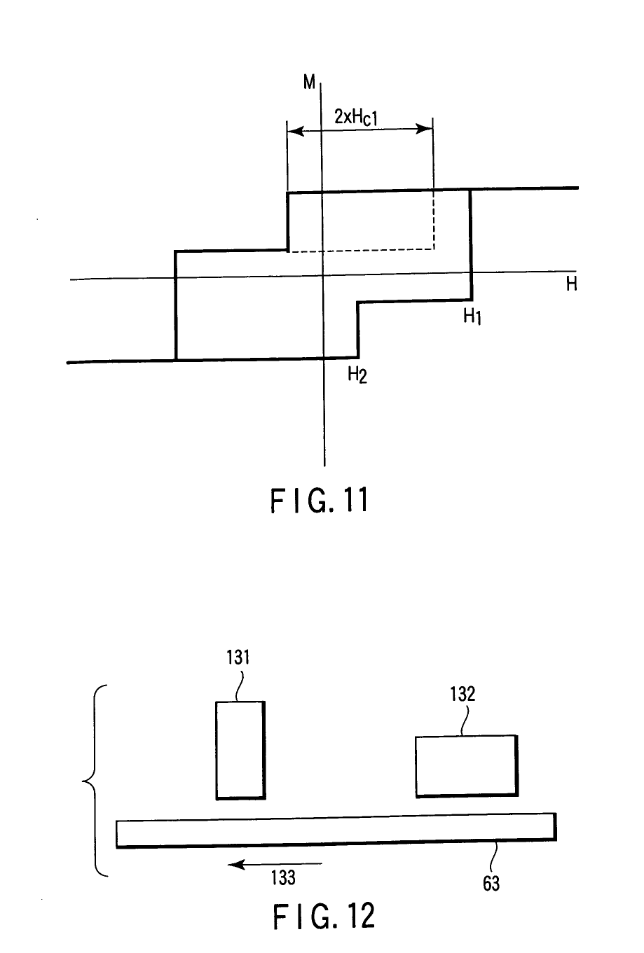

FIG. 11 shows another example of the M-H loop of the magnetic recording medium.

As shown in FIG. 11, even when H₁ and H₂ have the same sign, the state in which magnetizations in the first and second magnetic recording layers are antiferromagnetically coupled can be obtained.

This makes it possible to use an auxiliary head for applying a magnetic field smaller than the recording magnetic field after recording.

By the use of the magnetic recording apparatus having this arrangement, data can be recorded and reproduced at high SNR in and from the magnetic recording medium of the present invention having no large antiferromagnetic coupling energy.

FIG. 12 is a view schematically showing a magnetic recording/reproducing apparatus including an auxiliary head.

In FIG. 12, reference numeral 63 denotes a magnetic recording medium; 131, a recording head (a recording element of a recording/reproducing head); 132, an auxiliary head; and 133, the rotational direction of the medium. As shown in FIG. 12, the recording head 131 and auxiliary head 132 oppose the magnetic recording medium 63. Magnetic domains formed by the recording head 131 always pass below the auxiliary head 132 along with the rotation of the medium. The track positions of the recording head 131 and auxiliary head 132 can be designed to be the same. Since a magnetic field generated by the auxiliary head 132 can be smaller than the recording magnetic field, this condition can be readily met by setting the track width to be larger than that of the recording head. The auxiliary head 132 has two juxtaposed permanent magnets different in polarity. Therefore, magnetic fields in the recording direction and erasing direction are always applied to the medium. This auxiliary head 132 can be so designed as to be able to generate an arbitrary N/S magnetic field by a magnetic pole and coil. This achieves downsizing of the apparatus.

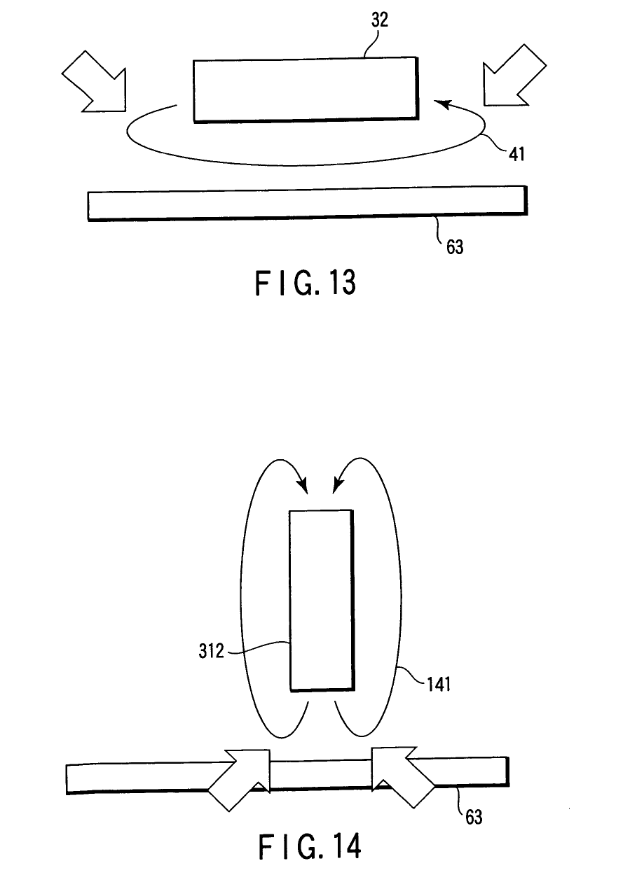

It is also possible to apply magnetic fields of the two polarities with a single magnet. As examples, FIGS. 13 and 14 illustrate examples of other auxiliary heads used in the present invention.

FIG. 13 shows a perpendicular magnetic recording type auxiliary head. An auxiliary head 32 is so set that its longitudinal direction is parallel to the surface of a medium 63. A magnetic flux 41 generated by the auxiliary head 32 in this case is as shown in FIG. 13. In positions indicated by blank arrows, up and down magnetic fields are applied to the medium 63 on the right- and left-hand sides, respectively, in FIG. 13.

FIG. 14 shows a longitudinal magnetic recording type auxiliary head. An auxiliary head 32 is so set that its longitudinal direction is perpendicular to the surface direction of a medium 63. A magnetic flux 41 generated by the auxiliary head 32 in this case is as shown in FIG. 14. In positions indicated by blank arrows, rightward and leftward magnetic fields are applied to the medium 63 on the right- and left-hand sides, respectively, in FIG. 14.

Since the magnetic field generated by the auxiliary head is smaller than the recording magnetic field, recorded information is not erased. The direction of the applied magnetic field of “1” and “0” must be included at least once. Although the lower limit of the applied magnetic field is theoretically H₂ shown in FIG. 8, the actual lower limit is larger than this lower limit due to the magnetic characteristic distribution in the medium and the design margin for an actual hard disk drive. H₂ is influenced by the demagnetizing field from the magnetization transition region. Therefore, H₂ is not uniquely determined with respect to a medium, and it is generally difficult to know H₂ including this distribution. Accordingly, the applied magnetic field is preferably large to such an extent that the recorded state is not destroyed.

A ring head can be used as a means for applying a magnetic field to the antiferromagnetically coupled perpendicular medium of the present invention.

This magnetic field applying means is a device having a magnetic circuit including an induction coil and magnetic pole at the end face of a floating slider, such as used in a common longitudinal HDD.

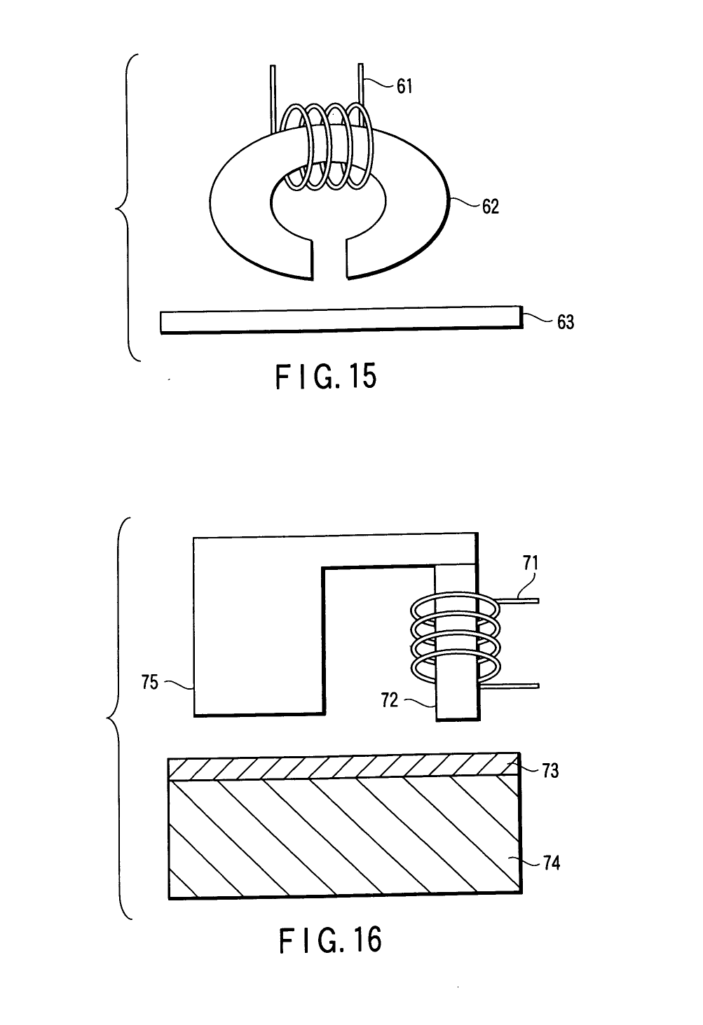

FIG. 15 is a view showing the arrangement of an example of a ring head applicable to the magnetic recording/reproducing apparatus of the present invention.

As shown in FIG. 15, this ring head has a magnetic pole 62 and a coil 61 wound on the magnetic pole 62 to supply an electric current for generating a magnetic field. The magnetic pole 62 has a ring-like shape whose N and S ends oppose each other via a gap which is a nonmagnetic material or space. As shown in FIG. 15, this ring head can apply a large, abruptly changing magnetic field to the vicinity of the gap.

A single pole head can also be used as the recording head.

FIG. 16 is a view showing the arrangement of a single pole head applicable to the magnetic recording/reproducing apparatus of the present invention.

As shown in FIG. 16, this single pole head has a bar-like magnetic pole 75, a recording head 72 attached to the magnetic pole 75, and a coil 71 wound on the recording head 72 to supply an electric current for generating a magnetic field. As shown in FIG. 16, this single pole head is applied to a double-layered film medium having a magnetic recording layer 73 backed by a soft magnetic under layer 74.

A magnetic flux generated from the magnetic pole end passes through the magnetic recording layer 73, and returns to the return magnetic pole 75 separated from the recording head 72 via the soft magnetic underlayer 74.

A recording system using this single pole head has the advantage that the presence of the soft magnetic underlayer 74 makes it possible to generate a large recording magnetic field.

As described above, the antiferromagnetically coupled perpendicular medium is expected to be able to efficiently record data even when a recording magnetic field is localized to the second magnetic recording layer. Therefore, a ring head can also be used instead of a single pole head by which a large recording magnetic field can be easily obtained.

The present invention will be described in detail below by way of its examples.

### EXAMPLE 1-1

A 2.5-inch glass substrate was prepared, and a 10-nm thick Ti seed layer and 20-nm thick Pt underlayer were formed on the substrate by sputtering. Then, 0.32-nm thick Co/0.78-nm thick Pt unit was sputtered for times, thereby forming a first magnetic recording layer. Sputter etching was performed on this first magnetic recording layer at an RF of 100 W in an Ar+N₂ gas at 0.5 Pa, in order to cause antimagnetic coupling between the first magnetic recording layer and a second magnetic recording layer by modifying the surface condition. Next, a 10-nm thick second magnetic recording layer made of (Co₈₀Pt₂₀)Ta₅-SiO₂ and a 3-nm thick C protective layer were stacked in this order by sputtering. After that, the C protective layer was coated with a lubricant to form a lubricating layer, thereby obtaining a magnetic recording medium.

A microstructure of the second magnetic recording layer was analyzed with a TEM-EDX method. The layer had a structure in which columnar magnetic crystal grains consisting primarily of CoPt with a diameter of about 9 nm were separated by a nonmagnetic portion consisting primarily of amorphous SiO₂. Little signal from Ta could be detected.

VSM measurement revealed that the first and second magnetic recording layers had a main axis of easy magnetization in a direction perpendicular to the plane of the layers.

A hysteresis loop was similar to that schematically shown in FIG. 2. When the absolute value of magnetic field was decreased from the negative saturation, magnetization abruptly changed twice at H₂ (−0.8 kOe) and H₁ (+3.8 kOe). This is presumably due to the antiferromagnetic exchange coupling interaction between the first and second magnetic recording layers. The first magnetic recording layer reversed at H₂ to make the spin directions in the first and second magnetic recording layers antiparallel. Since this state was stable in energy, it was held even under a zero magnetic field. When the magnetic field increased toward the positive side, magnetization in the second magnetic recording layer was forcedly reversed by an external magnetic field. This was the change at H₁. By cross sectional TEM observation, no layers other than the first and second magnetic recording layers were found between them. However, no antiferromagnetically coupled hysteresis loop could be obtained unless sputter etching was performed. Accordingly, the antiferromagnetic coupling was probably obtained by this sputter etching.

In addition, the recording/reproduction characteristics of the obtained magnetic recording medium were evaluated by a spin stand. The rotational speed was 4,500 rpm, the recording gap was 200 nm, and the gap of a reproduction head using a GMR element was 110 nm. The magnetic spacing was estimated to be 30 nm from the floating amount and the thickness of the lubricant. A ring type head was used as a recording head.

### COMPARATIVE EXAMPLE 1-1

A magnetic recording medium was formed following the same procedures as in Example 1-1 except that a 5-nm thick Pt layer was inserted as an interlayer between first and second magnetic recording layers.

In this medium, exchange coupling interaction between the first and second magnetic recording layers was presumably eliminated by the Pt interlayer.

The recording/reproduction characteristics of each magnetic recording medium were evaluated. Consequently, the Pw50 (an index of a recording resolution) of Example 1-1 was smaller by 10 nm than that of Comparative Example 1-1, and the S/Ndc (signal output at low density/medium noise in DC erased state) of Example 1-1 was larger by 3 dB than that of Comparative Example 1-1. The DC noise was reduced probably because reverse magnetic domains were suppressed. Also, Example 1-1 and Comparative Example 1-1 had substantially equal values of OW (an index indicating the ease of recording), although the Hc of Example 1-1 was higher than that of Comparative Example 1-1. This demonstrates that recording was well performed in Example 1-1.

### EXAMPLE 1-2

A 2.5-inch glass substrate was prepared, and a 4-nm thick MgO seed layer, 10-nm thick Cr underlayer, 100-nm thick CoZrNb soft magnetic underlayer, and 6-nm thick SiN-Pd underlayer were formed on the substrate by sputtering. On the SiN-Pd underlayer, 0.32-nm thick Co/0.78-nm thick Pt unit was sputtered for five times, thereby forming a first magnetic recording layer. After this first magnetic recording layer was formed, the sample was exposed to an Ar+O₂ gas at 1 Pa for 1 min. Then, on the first magnetic recording layer, a 5-nm thick second magnetic recording layer made of (Fe₅₀Pt₅₀)Cu₅-SiO₂ and a 3-nm thick C protective layer were stacked in this order by sputtering. After that, the C protective layer was coated with a lubricant, thereby obtaining a magnetic recording medium.

A microstructure of the second magnetic recording layer of the magnetic recording medium was observed with a TEM. Consequently, the layer had a structure in which columnar magnetic crystal grains consisting primarily of FePt and having a diameter of about 7 nm were separated by a nonmagnetic portion consisting primarily of amorphous SiO₂. VSM measurement revealed that the first and second magnetic recording layers had a main axis of easy magnetization in a direction perpendicular to the plane of the layers. Magnetic characteristics in the first and second magnetic recording layers were estimated from the hysteresis curves of this sample. As a consequence, a characteristic similar to that shown in FIG. 2 was obtained. H₂ was −2 kOe, and H₁ was 6 kOe. By cross sectional TEM observation, an oxide layer about 1 nm thick was found between the first and second magnetic recording layers. Therefore, the antiferromagnetic coupling was probably obtained between the first and second magnetic recording layers by this layer.

### COMPARATIVE EXAMPLE 1-2

A magnetic recording medium was formed following the same procedures as in Example 1-2 except that a 5-nm thick Pt layer was inserted as an interlayer between first and second magnetic recording layers. In this medium, exchange coupling interaction between the first and second magnetic recording layers was eliminated by the Pt interlayer.

The recording/reproduction characteristics of this magnetic recording medium were evaluated by a spin stand. The recording head was a single pole head.

The recording/reproduction characteristics of each medium were evaluated. Consequently, the Pw50 of Example 1-2 was smaller by 15 nm than that of Comparative Example 1-2, and the S/Ndc of Example 1-2 was larger by 2.5 dB than that of Comparative Example 1-2. The DC noise was reduced probably because reverse magnetic domains were suppressed. Also, Example 1-2 and Comparative Example 1-2 had substantially equal values of OW, although the Hc of Example 1-2 was higher than that of Comparative Example 1-2. This demonstrates that recording was well performed in Example 1-2.

### EXAMPLE 2-1

A magnetic recording medium was manufactured following the same procedures as in Example 1-1 except that an Ir interlayer M1 was formed by changing its thickness from 0.2 to 2.8 nm between first and second magnetic recording layers.

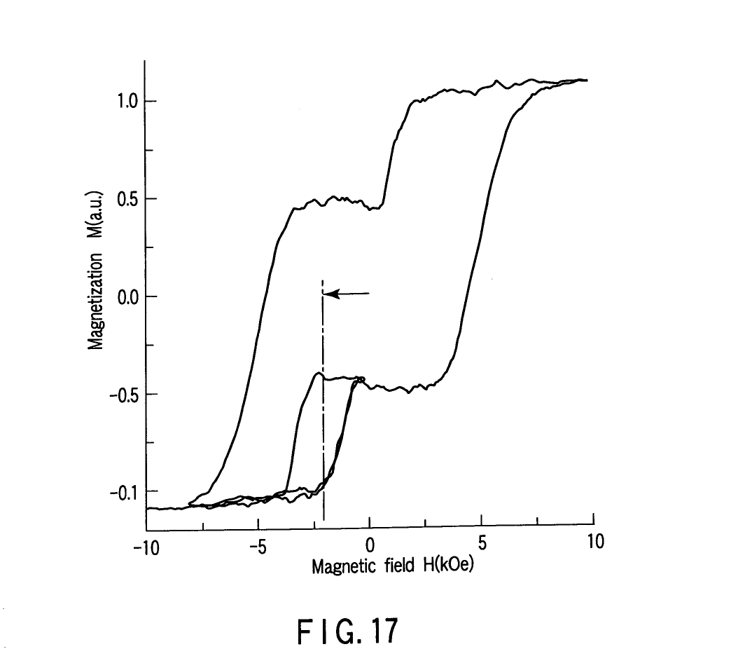

FIG. 17 shows the M-H loop of the obtained magnetic recording medium. An exchange coupling energy density J was calculated from the values of H₁ and H₂ of the hysteresis loop and the value of saturation magnetization Ms in each layer. Letting Hw (H_{cl}+H₂) be a shift magnetic field in a layer from which a minor loop is obtained, the exchange coupling energy surface density J is calculated by

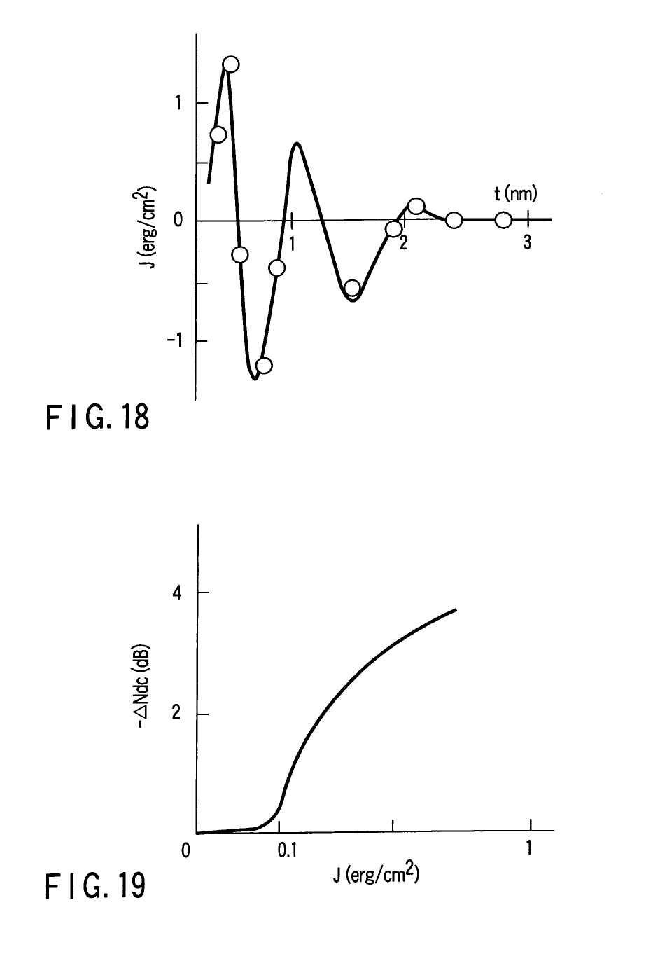

J=Hw×Ms×t

where t is the film thickness of a reversed layer. The dependence of J upon the Ir thickness was as shown in FIG. 18.

The sign of J was assumed to be negative when antiferromagnetic coupling was obtained. Although ferromagnetic coupling was obtained when the film thickness was smaller than 0.5 nm, antiferromagnetic coupling was obtained when the film thickness was larger than that. After the peak was found at about 0.8 nm, the coupling state returned to ferromagnetic one. That is, a vibrating behavior was observed. Similar tendencies were observed when Ru, Re, Rh, Tc, Au, Ag, Cu, Si, Fe, Ni, Pt, Pd, Cr, Mn, or Al were used as the interlayer M1. These elements were different in the value of J and in film thickness at which peak of antiferromagnetic coupling were obtained. It was found that it is preferable to form an interlayer containing at least any of these elements in order to obtain antiferromagnetic coupling. In addition, the effect was obtained by adding another element such as an element selected from, e.g., Ta, W, B, and Nb to M1.

The present inventors particularly studied in detail samples in which an element selected from Ru, Re, Rh, and Ir was used as the interlayer M1. Consequently, the exchange coupling energy surface density was estimated to be 1 to 5 erg/cm².

### EXAMPLE 2-2

A magnetic recording medium was obtained following the same procedures as in Example 2-1 except that a material formed by doping Si as a semiconductor with Co was used as an interlayer M1. The result was analogous to that shown in FIG. 18. When the interlayer M1 is a semiconductor, the exchange coupling interaction between the first and second magnetic recording layers presumably depends upon the number of electrons (carriers), and carrier polarization caused by the doped magnetic material probably increases the antiferromagnetic coupling energy. Similar results were obtained when Si, Ge, Sn, Te, AlP, GaN, GaP, GaAs, InSb, ZnO, ZnS, or ZnTe was used as a semiconductor and Co, Fe, Ni, Mn, or Cr was used as a magnetic material to be doped. From the foregoing, the generation of electrons (carriers) and carrier polarization are important, and at least a material formed by doping a semiconductor with a magnetic material is preferred.

In either case, an antiferromagnetic coupling of 0.1 erg/cm² or more was obtained when the film thickness was 2 nm or less.

In addition to the above medium, a plurality of magnetic recording media were formed by changing the material of the interlayer M1. The recording/reproduction characteristics of these media were evaluated in the same manner as in Example 1-1. A reduction −ΔNdc (dB) in medium noise in DC erased state with respect to the exchange coupling energy surface density J was studied. The result is shown in FIG. 19. As is evident from FIG. 19, a medium noise reduction by reversed magnetic domain suppression was obtained when J was 0.1 erg/cm² or more.

### EXAMPLE 3

A 2.5-inch glass substrate was prepared, and a 10-nm thick Ti seed layer and 20-nm thick Pt underlayer were formed on the substrate by sputtering. Then, an 8-nm thick Co₈₀Pt₂₀ first magnetic recording layer was formed, and a Co interlayer M2 was formed by changing the thickness from 0.05 to 2.8 nm. This thickness was t nm. After that, a 0.85-nm thick Ir interlayer M1, 5-nm thick (Fe₅₀Pt₅O)Zn₅-SiO₂ second magnetic recording layer, and 3-nm thick C protective layer were stacked in this order by sputtering. Then, the C protective layer was coated with a lubricant to form a lubricating layer, thereby obtaining a magnetic recording medium.

A microstructure of the second magnetic recording layer of the obtained magnetic recording layer was observed with a TEM. Consequently, the layer had a structure in which columnar magnetic crystal grains consisting primarily of FePt and having a diameter of about 7 nm were separated by a nonmagnetic portion consisting primarily of amorphous SiO₂. VSM measurement revealed that the first and second magnetic recording layers had a main axis of easy magnetization in a direction perpendicular to the plane of the layers.

FIG. 20 is a graph showing a change in the antiferromagnetic coupling energy surface density J as a function of the thickness t (nm) of the Co interlayer. As shown in FIG. 20, J increased when the Co thickness was 0.05 to 2 nm. This J increase was similarly obtained when the interlayer M2 was formed between the interlayer M1 and second magnetic recording layer.

Also, this J increase was found when a metal selected from Ru, Re, Rh, Ir, Tc, Au, Ag, Cu, Si, Fe, Ni, Pt, Pd, Cr, Mn, and Al, a semiconductor, or a material formed by doping a semiconductor with a magnetic material was used as the material of the interlayer M1.

The J increase was about 1.5 times when Co interlayers were formed between the Ir interlayer and first magnetic recording layer and between the Ir interlayer and second magnetic recording layer.

A tendency analogous to that shown in FIG. 20 was obtained when the Co interlayer was made of an alloy mainly containing Co. When Cr, Ta, W, B, or SiO₂ was added, the J increase was about 0.7 times. However, when the recording/reproduction characteristics of this medium were checked, the S/Ndc improved by 2 dB.

### EXAMPLE 4-1

A 2.5-inch glass substrate was prepared, and a 10-nm thick Ti seed layer and 20-nm thick Pt underlayer were formed on the substrate by sputtering. Then, an 8-nm thick Co₈₀Pt₂₀ first magnetic recording layer was formed, and an Au interlayer M4 was formed by changing the thickness from 0.2 to 2 nm. This thickness was t₃ nm. After that, a Co interlayer M2 was formed by changing the thickness from 0.05 to 2 nm. This thickness was t₂ nm. In addition, an Ir interlayer M1 was formed by changing the thickness from 0.2 to 2 nm. This thickness was t₁ nm. After that, a 5-nm thick (Fe₅₀Pt₅₀)Zn₅-SiO₂ second magnetic recording layer and 3-nm thick C protective layer were stacked in this order by sputtering. Then, the C protective layer was coated with a lubricant to form a lubricating layer, thereby obtaining a magnetic recording medium.

A microstructure of the second magnetic recording layer of the obtained magnetic recording medium was observed with a TEM. Consequently, the layer had a structure in which columnar magnetic crystal grains consisting primarily of FePt and having a diameter of about 7 nm were separated by a nonmagnetic portion consisting primarily of amorphous SiO₂.

VSM measurement revealed that the first and second magnetic recording layers had a main axis of easy magnetization in a direction perpendicular to the film surface. The film thickness t₃ of the Au interlayer and the film thickness t₁ of the Ir interlayer were adjusted such that one or all of the first and second magnetic recording layers and Co interlayer were coupled by antiferromagnetic exchange coupling. Since t₃, t₁, and J had a relationship similar to that shown in FIG. 18, adjustment of the coupling direction in each layer was arbitrary.

A plurality of media different in t₁, t₂, and t₃ were manufactured so that the first and second magnetic recording layers were antiferromagnetically coupled, and the recording/reproduction characteristics were evaluated by a spin stand. The Pw50 was smaller by 5 nm than that of Example 3, and the S/Ndc was larger by 2 dB than that of Example 3. The DC noise was presumably reduced because reversed magnetic domains were further suppressed. Also, the OW was 35 dB, demonstrating that data was well recorded.

t₁, t₂, and t₃ were adjusted such that the magnetization directions in the first and second magnetic recording layers were parallel, the magnetization directions in the first magnetic recording layer and Co interlayer were antiparallel, and the magnetization directions in the second magnetic recording layer and Co interlayer were antiparallel. When the recording/reproduction characteristics were evaluated in the same manner as above, the S/Ndc was larger by 1.5 dB than in the example. In addition, a signal output increase of about 20% was found.

The above effects were found when a metal layer selected from Ru, Re, Rh, Ir, Tc, Au, Ag, Cu, Si, Fe, Ni, Pt, Pd, Cr, Mn, and Al and a material selected from a semiconductor and a material formed by doping a semiconductor with a magnetic material were used instead of the interlayer and Au interlayer. Also, the above effects were found when an alloy mainly containing Co was used as the Co interlayer. Furthermore, the same effects were obtained when an interlayer M5 was formed between the second magnetic recording layer and interlayer.

Following the same procedures as above, a medium was manufactured by forming a Co interlayer between a second magnetic recording layer and Ir interlayer, and an Au interlayer between the second magnetic recording layer and Co interlayer. Even with this medium, antiferromagnetic coupling energy equivalent to that described above was obtained, and effects analogous to those described above were obtained for the recording/reproduction characteristics.

### EXAMPLE 4-2

A 2.5-inch glass substrate was prepared, and a 5-nm thick NiAl seed layer, 20-nm thick CrMn underlayer, 5-nm CoCrPtTa first magnetic recording layer were formed on the substrate by sputtering. Then, an Ir interlayer M4 was formed by changing the thickness from 0.2 to 2 nm. This thickness was t₃ nm. In addition, a Co interlayer M2 was formed by changing the thickness from 0.05 to 2 nm. This thickness was t₂ nm. After that, a 0.78-nm thick Ru interlayer Ml, 7-nm thick CoCrPtTaB second magnetic recording layer, and 3-nm thick C protective layer were stacked in this order by sputtering. Then, the C protective layer was coated with a lubricant to form a lubricating layer, thereby obtaining a magnetic recording medium. A microstructure of the second magnetic recording layer of the magnetic recording medium was observed with a TEM. Consequently, the layer had a structure in which columnar magnetic crystal grains consisting primarily of CoCr and having a diameter of about 9 nm were separated by a nonmagnetic portion consisting primarily of amorphous CoO and segregated Cr.

VSM measurement revealed that the first and second magnetic recording layers had a main axis of easy magnetization in the longitudinal direction of the layers. The film thickness t₃ of the Ir interlayer and the film thickness t₂ of the Co interlayer were adjusted such that one or all of the first and second magnetic recording layers and Co interlayer were coupled by antiferromagnetic exchange coupling. Since t₃, t₂, and J had a relationship similar to that shown in FIG. 18, adjustment of the coupling direction in each layer was arbitrary.

### EXAMPLE 4-3

A magnetic recording medium was formed following the same procedures as in Example 4-2 except that no Ir interlayer M4 was formed.

The antiferromagnetic coupling energy between the first and second magnetic recording layers in Example 4-3 was substantially the same as in Example 4-2.

The recording/reproduction characteristics of these media were evaluated by a spin stand. The recording head was a ring head. The Pw50 of Example 4-2 was smaller by 10 to 15 nm than that of Example 4-3. The S/Nm as the ratio of signal output to medium noise at a linear recording density of 400 kfci of Example 4-2 was larger by 1 to 2 dB than that of Example 4-3.

Also, a medium in which a second magnetic recording layer and Co interlayer were antiferromagnetically coupled was formed, and the recording/reproduction characteristics of the medium were similarly evaluated. Consequently, the Pw50 of Example 4-2 was larger by about 5 nm than that of Example 4-3, but the signal output increased by about 10%. That is, a medium suited to magnetic recording at a relatively low recording density was obtained.

The above effect was found when metal layers containing at least Ru, Re, Rh, Ir, Tc, Au, Ag, Cu, Si, Fe, Ni, Pt, Pd, Cr, Mn, and Al and a material selected from a semiconductor and a material formed by doping a semiconductor with a magnetic material were used instead of the Ru interlayer and Ir interlayer. Also, the above effect was found when an alloy containing Co in larger amount was used as the Co interlayer. Furthermore, the same effect was obtained when an Ir interlayer was formed between the second magnetic recording layer and Co interlayer.

Following the same procedures as above, a medium was manufactured by forming an interlayer M3 between a second magnetic recording layer and interlayer M1, and an interlayer MS between the second magnetic recording layer and interlayer M3. Even with this medium, antiferromagnetic coupling energy equivalent to that described above was obtained, and effects analogous to those described above were obtained for the recording/reproduction characteristics.

### EXAMPLE 4-4

A medium using Al₂O₃ as interlayers M4 and MS was formed, and its recording/reproduction characteristics were evaluated in the same manner as above. The Pw50 of Example 4-4 was smaller by 15 nm than that of Example 4-2. The S/Nm at a linear recording density of 400 kfci of Example 4-4 was larger by 2 dB than that of Comparative Example 4-2. These improvements were obtained probably because the diffusion preventing effect was increased by the oxide. A similar medium noise reducing effect was found when the material of the interlayers M4 and M5 was represented by M-G wherein M is selected from Si, Al, Zn, Sn, In, Zr, Co, Fe, and B, and G is represented by O, N, C, or H.

### EXAMPLE 5-1

A 2.5-inch glass substrate was prepared, and a 40-nm thick Pt underlayer and 5-nm thick SiN-Pd underlayer were formed on the substrate by sputtering. Subsequently, 0.32-nm thick Co/0.5-nm thick Pt unit was sputtered for five times, thereby forming a first magnetic recording layer. In addition, a Pt interlayer M6 was formed by changing the thickness from 0.005 to 2 nm. This thickness was t nm. Furthermore, a 0.88-nm thick Ir interlayer M1 was formed. After that, sputtering was repeated eight times by using 0.28-nm thick Co/0.7-nm thick Pd as a unit, thereby obtaining a second magnetic recording layer. Then, a 3-nm thick C protective layer was formed by sputtering and coated with a lubricant to form a lubricating layer, thereby obtaining a magnetic recording medium.

A microstructure of the second magnetic recording layer of the obtained magnetic recording medium was observed with a TEM. Consequently, the layer had a structure in which columnar magnetic crystal grains consisting primarily of Co and having a diameter of about 7 nm were separated by a nonmagnetic portion consisting primarily of amorphous CoO.

VSM measurement revealed that the first and second magnetic recording layers had a main axis of easy magnetization in a direction perpendicular to the surface of the layer.

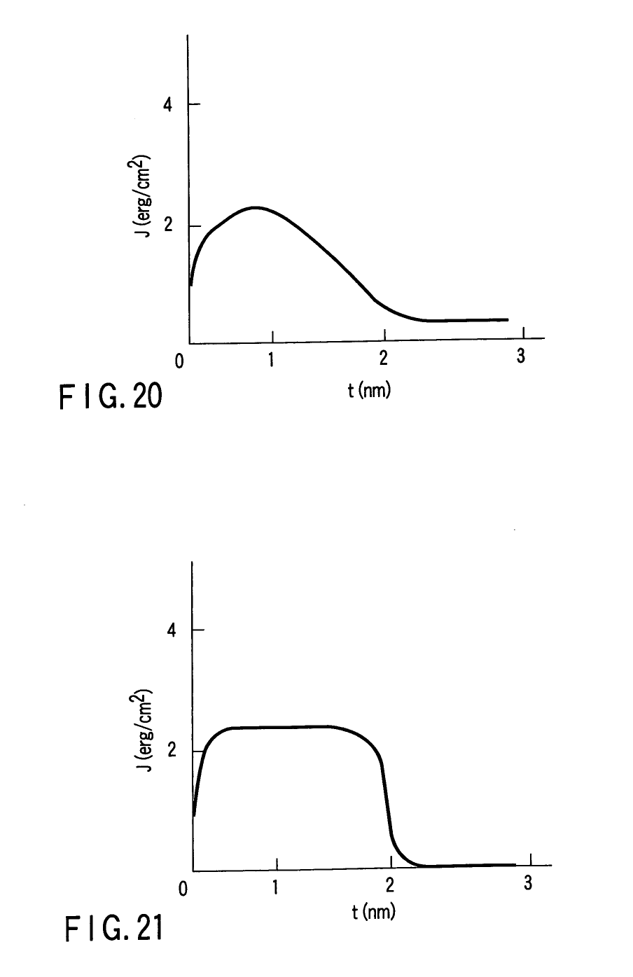

FIG. 21 is a graph showing the relationship between the thickness t of the Pt interlayer M6 and a magnitude J of the antiferromagnetic coupling energy. As shown in FIG. 21, J increased when the thickness was 0.05 to 2 nm. J increased probably because the perpendicular magnetic anisotropy was increased by the presence of the Pt layer.

A similar effect was obtained as long as the interlayer was selected from at least Ir, Rh, Re, and Ru, and the interlayer was a layer containing an element selected from at least Pt, Pd, Ru, and Re. Also, a similar effect was obtained when, e.g., a Co interlayer described above was formed.

### EXAMPLE 6

Magnetic recording media were obtained following the same procedures as in Examples 1-1 to 5-1 except that a first recording layer was additionally formed on a second magnetic recording layer.

In each medium, the antiferromagnetic coupling energy increased by about 1.8 times.

Additional advantages and modifications will readily occur to those skilled in the art. Therefore, the invention in its broader aspects is not limited to the specific details and representative embodiments shown and described herein. Accordingly, various modifications may be made without departing from the spirit and scope of the general inventive concept as defined by the appended claims and their equivalents.

What is claimed is:

1. A magnetic recording medium comprising a nonmagnetic substrate, a first magnetic recording layer formed on the nonmagnetic substrate, and a second magnetic recording layer formed on the first magnetic recording layer, wherein the first and second magnetic recording layers interact each other to make the magnetization directions thereof antiparallel, and the axis of easy magnetization in each of the first and second magnetic recording layers is perpendicular to the plane of the layers.

2. A medium according to claim 1, further comprising a soft magnetic layer between the nonmagnetic substrate and first magnetic recording layer.

3. A medium according to claim 1, wherein when a magnetic field is applied perpendicularly to the plane of the magnetic recording layer until magnetization saturated in one direction is reversed and saturated in the opposite direction, the sign of the magnetic field upon reversal in the first magnetic recording layer is different from that in the second magnetic recording layer.

4. A medium according to claim 1, wherein the antiferromagnetic exchange coupling energy density during the interaction is not less than 0.01 erg/cm².

5. A medium according to claim 1, wherein the second magnetic recording layer contains magnetic grains, and a nonmagnetic material present between the magnetic grains.

6. A medium according to claim 1, wherein at least one of the first and second magnetic recording layers has a multilayered structure in which a ferromagnetic layer containing Co in larger amount and a nonmagnetic layer containing one of Pd and Pt in larger amount are alternately stacked.

7. A medium according to claim 1, further comprising not less than one interlayer selected from interlayers M1 to M5 between the first and second magnetic recording layers,
wherein the combination of layers is selected from
first magnetic recording layer/M1/second magnetic recording layer,
first magnetic recording layer/M2/M1/second magnetic recording layer, first magnetic recording layer/M4/M2/M1/second magnetic recording layer,
first magnetic recording layer/M2/M1/M3/second magnetic recording layer, first magnetic recording layer/M4/M2/M1/M3/second magnetic recording layer,
first magnetic recording layer/M2/M1/M3/M5/second magnetic recording layer, first magnetic recording layer/M4/M2/M1/M3/M5/second magnetic recording layer,
first magnetic recording layer/M1/M3/second magnetic recording layer, and first magnetic recording layer/M1/M3/M5/second magnetic recording layer,
the interlayer M1 substantially consists of a nonmagnetic material having a thickness of not more than 2 nm, and not less than two of the first magnetic recording layer, interlayers M2 and M3, and second magnetic recording layer are coupled by antimagnetic exchange coupling.

8. A medium according to claim 7, wherein the interlayer M1 contains one of a semiconductor and a magnetic material-doped semiconductor.

9. A medium according to claim 7, wherein the interlayer M1 mainly contains at least one material selected from the group consisting of at least Ru, Re, Rh, Ir, Tc, Au, Ag, Cu, Si, Fe, Ni, Pt, Pd, Cr, Mn, and Al.

10. A medium according to claim 9, wherein the interlayer M1 mainly contains at least one material selected from the group consisting of Ru, Rh, and Ir.

11. A medium according to claim 7, wherein the interlayer M2 substantially consists of a Co-based alloy.

12. A medium according to claim 7, wherein the interlayer M3 substantially consists of a Co-based alloy.

13. A medium according to claim 7, wherein the interlayer M4 mainly contains at least one material selected from the group consisting of at least Ru, Re, Rh, Ir, Tc, Au, Ag, Cu, Si, Fe, Ni, Pt, Pd, Cr, Mn, Al, a semiconductor, and a magnetic material-doped semiconductor.

14. A medium according to claim 7, wherein the interlayer M4 is represented by formula M-G wherein M is selected from the group consisting of Si, Al, Zn, Sn, In, Zr, Co, Fe, and B, and G is selected from the group consisting of O, N, C, and H.

15. A medium according to claim 8, wherein the interlayer M5 contains at least one material in larger amount, selected from the group consisting of at least Ru, Re, Rh, Ir, Tc, Au, Ag, Cu, Si, Fe, Ni, Pt, Pd, Cr, Mn, Al, a semiconductor, and a magnetic material-doped semiconductor.

16. A medium according to claim 7, wherein the interlayer M5 is represented by formula M-G wherein M is selected from the group consisting of Si, Al, Zn, Sn, In, Zr, Co, Fe, and B, and G is selected from the group consisting of O, N, C, and H.

17. A medium according to claim 1, further comprising not less than three interlayers selected from interlayers M1 to M7 between the first and second magnetic recording layers,
wherein the combination of layers is selected from
first magnetic recording layer/M6/M4/M1/second magnetic recording layer,
first magnetic recording layer/M6/M4/M1/M3/second magnetic recording layer,
first magnetic recording layer/M6/M4/M1/M5/second magnetic recording layer,
first magnetic recording layer/M6/M4/M1/M3/M5/second magnetic recording layer,
first magnetic recording layer/M6/M4/M1/M5/M7/second magnetic recording layer,
first magnetic recording layer/M6/M4/M1/M3/M5/M7/second magnetic recording layer,
first magnetic recording layer/M6/M4/M2/M1/second magnetic recording layer,
first magnetic recording layer/M6/M4/M2/M1/M3/second magnetic recording layer,
first magnetic recording layer/M6/M4/M2/M1/M5/second magnetic recording layer,
first magnetic recording layer/M6/M4/M2/M1/M3/M5/second magnetic recording layer,
first magnetic recording layer/M6/M4/M2/M1/M5/M7/second magnetic recording layer,
first magnetic recording layer/M6/M4/M2/M1/M3/M5/M7/second magnetic recording layer,
first magnetic recording layer/M1/M5/M7/second magnetic recording layer,
first magnetic recording layer/M2/M1/M5/M7/second magnetic recording layer,
first magnetic recording layer/M4/M1/M5/M7/second magnetic recording layer,
first magnetic recording layer/M4/M2/M1/M5/M7/second magnetic recording layer, first magnetic recording layer/M1/M3/M5/M7/second magnetic recording layer,
first magnetic recording layer/M2/M1/M3/M5/M7/second magnetic recording layer, first magnetic recording layer/M4/M1/M3/M5/M7/second magnetic recording layer, and
first magnetic recording layer/M4/M2/M1/M3/M5/M7/second magnetic recording layer,
the interlayer M1 substantially consists of a nonmagnetic material having a thickness of not more than 2 nm, not less than two of the first magnetic recording layer, interlayers M2 and M3, and second magnetic recording layer are coupled by antimagnetic exchange coupling, and the interlayers M6 and M7 contain at least one material selected from the group consisting of Pt, Pd, Ru, and Re.

18. A medium according to claim 17, wherein the interlayer M1 contains one of a semiconductor and a magnetic material-doped semiconductor.

19. A medium according to claim 17, wherein the interlayer M1 mainly contains at least one material selected from the group consisting of at least Ru, Re, Rh, Ir, Tc, Au, Ag, Cu, Si, Fe, Ni, Pt, Pd, Cr, Mn, and Al.

20. A medium according to claim 19, wherein the interlayer M1 contains at least one material in larger amount, selected from the group consisting of Ru, Rh, and Ir.

21. A medium according to claim 17, wherein the interlayer M2 substantially consists of a Co-based alloy.

22. A medium according to claim 17, wherein the interlayer M3 substantially consists of a Co-based alloy.

23. A medium according to claim 17, wherein the interlayer M4 mainly contains at least one material selected from the group consisting of at least Ru, Re, Rh, Ir, Tc, Au, Ag, Cu, Si, Fe, Ni, Pt, Pd, Cr, Mn, Al, a semiconductor, and a magnetic material-doped semiconductor.

24. A medium according to claim 17, wherein the interlayer M4 is represented by formula M-G wherein M is one member selected from the group consisting of Si, Al, Zn, Sn, In, Zr, Co, Fe, and B, and G is one member selected from the group consisting of O, N, C, and H.

25. A medium according to claim 17, wherein the interlayer MS mainly contains at least one material selected from the group consisting of at least Ru, Re, Rh, Ir, Tc, Au, Ag, Cu, Si, Fe, Ni, Pt, Pd, Cr, Mn, Al, a semiconductor, and a magnetic material-doped semiconductor.

26. A medium according to claim 17, wherein the interlayer MS is represented by formula M-G wherein M is one member selected from the group consisting of Si, Al, Zn, Sn, In, Zr, Co, Fe, and B, and G is one member selected from the group consisting of O, N, C, and H.

27. A medium according to claim 1, wherein not less than three first and second magnetic recording layers are alternately stacked.

28. A magnetic recording medium comprising a nonmagnetic substrate, a first magnetic recording layer formed on the nonmagnetic substrate, and a second magnetic recording layer formed on the first magnetic recording layer, wherein the first and second magnetic recording layers interact each other to make the magnetization directions thereof antiparallel, the axis of easy magnetization in each of the first and second magnetic recording layers is parallel to the plane of the layer,
the magnetic recording medium further comprises not less than three interlayers selected from interlayers M1 to M7 between the first and second magnetic recording layers, the combination of layers is selected from
first recording layer/M4/M2/M1/second recording layer, first recording layer/M6/M4/M2/M1/second recording layer,
first recording layer/M4/M2/M1/M3/second recording layer, first recording layer/M6/M4/M2/M1/M3/second recording layer,
first recording layer/M2/M1/M3/M5/second recording layer, first recording layer/M4/M2/M1/M3/M5/second recording layer, first recording layer/M6/M4/M2/M1/M3/M5/second recording layer,
first recording layer/M2/M1/M3/M5/M7/second recording layer, first recording layer/M4/M2/M1/M3/M5/M7/second recording layer, first recording layer/M6/M4/M2/M1/M3/M5/M7/second recording layer,
first recording layer/M1/M3/M5/second recording layer, and first recording layer/M1/M3/M5/M7/second recording layer,
first magnetic recording layer/M6/M4/M1/second magnetic recording layer,
first magnetic recording layer/M6/M4/M1/M3/second magnetic recording layer,
first magnetic recording layer/M6/M4/M/M5/second magnetic recording layer,
first magnetic recording layer/M6/M4/M1/M5/M7/second magnetic recording layer,
first magnetic recording layer/M6/M4/M1/M3/M5/second magnetic recording layer,
first magnetic recording layer/M6/M4/M1/M3/M5/M7/second magnetic recording layer,
first magnetic recording layer/M6/M4/M2/M1/M5/second magnetic recording layer,
first magnetic recording layer/M6/M4/M2/M1/M5/M7/second magnetic recording layer,
first magnetic recording layer/M1/M5/M7/second magnetic recording layer,
first magnetic recording layer/M2/M1/M5/M7/second magnetic recording layer,
first magnetic recording layer/M4/M1/M5/M7/second magnetic recording layer,
first magnetic recording layer/M4/M2/M1/M5/M7/second magnetic recording layer,
first magnetic recording layer/M4/M1/M3/M5/M7/second magnetic recording layer, and
first magnetic recording layer/M4/M2/M1/M3/M5/M7/second magnetic recording layer,
the interlayer M1 mainly contains at least one material selected from the group consisting of Ru, Rh, Re, and Ir, the interlayers M2 and M3 are made of a material containing an alloy which consists primarily of Co, the interlayers M4 and MS mainly contain at least one material selected from the group consisting of at least Ru, Re, Rh, Ir, Tc, Au, Ag, Cu, Si, Fe, Ni, Pt, Pd, Cr, Mn, Al, a semiconductor, and a magnetic material-doped semiconductor, the interlayers M6 and M7 contain at least one material selected from the group consisting of Pt, Pd, Ru, and Re, each of the interlayers M1, M2, M3, M4, and M5 has a thickness of not more than 2 nm, and at least two of the first magnetic recording layer, interlayers M2 and M3, and second magnetic recording layer have antiferromagnetic exchange coupling.

29. A medium according to claim 28, wherein not less than three first and second magnetic recording layers are alternately stacked.

30. A magnetic recording/reproducing apparatus comprising:
a magnetic recording medium having a nonmagnetic substrate, a first magnetic recording layer formed on the nonmagnetic substrate, and a second magnetic recording layer formed on the first magnetic recording layer, the first and second magnetic recording layers interacting each other to make the magnetization directions thereof antiparallel, and the axis of easy magnetization in each of the first and second magnetic recording layers being perpendicular to the plane of the layer;
a driving mechanism which supports and rotates the magnetic recording medium; and
a mechanism which applies a recording magnetic field to the recording magnetic medium.

31. An apparatus according to claim 30, further comprising an auxiliary head which applies a magnetic field smaller than the recording magnetic field to the magnetic recording medium.

32. A magnetic recording/reproducing apparatus comprising:
a magnetic recording medium having a nonmagnetic substrate, a first magnetic recording layer formed on the nonmagnetic substrate, and a second magnetic recording layer formed on the first magnetic recording layer,
a driving mechanism which supports and rotates the magnetic recording medium; and
a mechanism which applies a recording magnetic field to the recording magnetic medium,
wherein the first and second magnetic recording layers interact each other to make the magnetization directions thereof antiparallel, the axis of easy magnetization in each of the first and second magnetic recording layers is parallel to the plane of the layer,
the magnetic recording medium further comprises not less than three interlayers selected from interlayers M1 to M7 between the first and second magnetic recording layers, the combination of layers is selected from
first recording layer/M4/M2/M1/second recording layer, first recording layer/M6/M4/M2/M1/second recording layer,
first recording layer/M4/M2/M1/M3/second recording layer, first recording layer/M6/M4/M2/M1/M3/second recording layer,
first recording layer/M2/M1/M3/M5/second recording layer, first recording layer/M4/M2/M1/M3/M5/second recording layer, first recording layer/M6/M4/M2/M1/M3/M5/second recording layer,
first recording layer/M2/M1/M3/M5/M7/second recording layer, first recording layer/M4/M2/M1/M3/M5/M7/second recording layer, first recording layer/M6/M4/M2/M1/M3/M5/M7/second recording layer,
first recording layer/M1/M3/M5/second recording layer, and first recording layer/M1/M3/M5/M7/second recording layer,
first magnetic recording layer/M6/M4/M1/second magnetic recording layer,
first magnetic recording layer/M6/M4/M1/M3/second magnetic recording layer,
first magnetic recording layer/M6/M4/M1/M5/second magnetic recording layer,
first magnetic recording layer/M6/M4/M1/M5/M7/second magnetic recording layer,
first magnetic recording layer/M6/M4/M1/M3/M5/second magnetic recording layer,
first magnetic recording layer/M6/M4/M1/M3/M5/M7/second magnetic recording layer,
first magnetic recording layer/M6/M4/M2/M1/M5/second magnetic recording layer,
first magnetic recording layer/M6/M4/M2/M1/M5/M7/second magnetic recording layer,
first magnetic recording layer/M1/M5/M7/second magnetic recording layer,
first magnetic recording layer/M2/M1/M5/M7/second magnetic recording layer,
first magnetic recording layer/M4/M1/M5/M7/second magnetic recording layer,
first magnetic recording layer/M4/M2/M1/M5/M7/second magnetic recording layer,
first magnetic recording layer/M4/M1/M3/M5/M7/second magnetic recording layer, and
first magnetic recording layer/M4/M2/M1/M3/M5/M7/second magnetic recording layer,
the interlayer M1 mainly contains at least one material selected from the group consisting of Ru, Rh, Re, and Ir, the interlayers M2 and M3 are made of a material containing an alloy which consists primarily of Co, the interlayers M4 and MS mainly contain at least one material selected from the group consisting of at least Ru, Re, Rh, Ir, Tc, Au, Ag, Cu, Si, Fe, Ni, Pt, Pd, Cr, Mn, Al, a semiconductor, and a magnetic material-doped semiconductor, the interlayers M6 and M7 contain at least one material selected from the group consisting of Pt, Pd, Ru, and Re, each of the interlayers M1, M2, M3, M4, and MS has a thickness of not more than 2 nm, and at least two of the first magnetic recording layer, interlayers M2 and M3, and second magnetic recording layer have antiferromagnetic exchange coupling.
